(19) United States
(12) Patent Application Publication
(10) Pub. No.: US 2005/0030892 A1
(43) Pub. Date: Feb. 10, 2005

(54) System for providing network load distribution

(76) Inventors: David A. Hagen, Southern Pines, NC (US); Rick Stefanik, Pinehurst, NC (US)

Correspondence Address: SMITH MOORE LLP, P.O. BOX 21927, GREENSBORO, NC, 27420, US

(21) Appl. No.: 10/874,694

(22) Filed: Jun. 23, 2004

Related U.S. Application Data
(60) Provisional application No. 60/480,962, filed on Jun. 23, 2003.

(51) Int. Cl. H04L 12/26

(52) U.S. Cl. 370/229

(57) ABSTRACT

A system for providing network load distribution including a network having a number of portals that are configured to access portal services hosted by the network and a plurality of control nodes on the network that are configured to establish data connections with the portals on the network. The control nodes form a virtual local area network (VLAN) that includes multicast islands and singlecast bridges for broadcasting data to other nodes on the network. When a portal requests to access a portal service hosted on the network, a portal having the requested service is identified and authenticated by one of the control nodes, and a data connection is established between the identified portal and the requesting portal for sharing the requested service.

This application claims the benefit of U.S. Provisional Application No. 60/480,962, filed on Jun. 23, 2003.

### BACKGROUND OF THE INVENTION

The present invention relates to a multimedia communication that provides efficient, global load balancing.

Gatelinx Corporation, assignee of the present invention, has proposed several systems, methods, and apparatuses for improving sales to potential consumers through a number of portals, such as stationary kiosks, set top boxes, portable kiosks, desktop computers, laptops, handheld computers, and personal digital assistants. These various systems provide for real time data transfer between the portals over the internet. One problem associated with such data transfer is that when requests are generated from multiple clients or portals on the network, all of the requests are sent to one central server that is load balanced. That central server then segments the requests among all of the servers in its cluster. The problem is that the central device cannot receive an infinite number of connections. Rather, the central device can become overloaded with requests and all of the client requests are still sent to that one central server which may reside on one or many redundant networks. Thus, there is no way to manage and direct network traffic on a large scale.

Accordingly, there is a need in the art for a system that provides for efficient, global load balancing.

### BRIEF SUMMARY OF THE INVENTION

A system for providing network load distribution including a network having a number of portals that are configured to access portal services hosted by the network and a plurality of control nodes on the network that are configured to establish data connections with the portals on the network. The control nodes form a virtual local area network (VLAN) that includes multicast islands and singlecast bridges for broadcasting data to other nodes on the network. When a portal requests to access a portal service hosted on the network, a portal having the requested service is identified and authenticated by one of the control nodes. A data connection is established between the identified portal and the requesting portal for sharing the requested service.

### DETAILED DESCRIPTION OF THE INVENTION

The present invention provides a peer-to-peer network that allows for the rapid discovery of peer nodes running specific services, the formulation of sub-networks with those nodes, and monitoring and maintaining of those sub-networks. The communication system includes a managed portal network that may be operated by one or more service providers. The managed portal network interfaces with the internet and particularly, with the world wide web. A plurality of portals may be connected to the managed portal network, indirectly through an internet service provider, or through some other medium. The portals of the present invention may comprise computers that may reside in the form of stationary kiosks, portable kiosks, desktop computers, laptops, handheld computers, set-top boxes, circuit boards that can be integrated within televisions as receiving/processing apparatuses, and personal digital assistants, for example.

To aid in describing the communication system of the present invention, an example of a desktop computer that requests to text chat is used throughout this description. It should be understood, however, the present invention is not limited to this particular application. Rather, an infinite number of applications and requests may be utilized in accordance with the present invention.

The managed portal network may host a plurality of services that are available to its portals, such as media streamer, text and data transfer, file transfer, and remote control of I/O devices, which are referred to herein as global services. These global services may be accessible to any portal on the managed portal network, regardless of whether the portals are in the same virtual local area network (VLAN). Whenever a portal logs onto the managed portal network, a data connection is created between the portal and a control node located on the network. That control node assigns a unique identifier to the portal, which allows the portal to send requests to any other portal on the network during the duration of that portal's current session on the network. The system may be configured so that one control node is assigned to one portal or that one control node keeps track of multiple portal's service capabilities. All of the control nodes may form a control node VLAN.

A VLAN is a collection of nodes that can multicast and singlecast data among its members. The formation of a new VLAN is overseen by the control node, which determines the connection details and encryption keys, etc. The VLAN consists of multicast “islands” and singlecast “bridges.” For example, if ten users are behind firewall A, twenty users behind firewall B and 200 users behind firewall C, the VLAN will consist of islands behind firewalls A, B and C. In this instance, one or more nodes (called retransmitters) from each firewall form a single data transport connection to the other islands. Specifically, one or more nodes from firewall A connect to modes behind firewalls B and C, nodes from firewall C connect to firewalls B and A, and finally, nodes from firewall B connect to firewalls A and C. Data received by the retransmitters from nodes on its side of the firewall are rebroadcasted through a singlecast bridge, and data received from the singlecast bridge is retransmitted as multicast data to all nodes within the firewall. Referring again to the example, if a node behind firewall A wants to broadcast “Lets get this meeting started,” the data is multicasted to all nodes behind the firewall. At least one of these nodes is a retransmitter (other retransmitters may be designated as “idle” and serve only as backups incase the primary fails). The retransmitter sends the same message to the primary retransmitters behind firewalls B and C. These retransmitters multicast the message to all nodes behind their respective firewalls. The data is intended for a single recipient, as opposed to being broadcast to all nodes. The data is handled by the creation of a temporary data transfer connection between the two nodes and the secured data is transferred over this new connection.

After logging onto the managed portal network, each portal is capable of running and requesting specific global services. If the portal is a peer node, then when it logs onto the managed portal network the portal sends information to its control node about its currently available global services. For example, if the desktop computer is currently able to run a text chat feature, the desktop notifies its control node of that availability. The peer portal may also request to be logged on to one or more peer-accessible VLANs.

If the portal is a control node, then when it logs onto the managed portal network it requests to be added to the control node VLAN, which is constant VLAN that monitors the available control nodes on the network.

If the portal is a service controller, then when it logs onto the managed portal network it requests to be added to the service controller VLAN for its specified global service. For example, a text chat service controller will be added to the text chat VLAN, not the media stream VLAN. Service controllers are located on the network that control on the backend the global services and features. Requests to join specified service VLANs are treated as global service requests, which are transmitted to the control nodes that maintain availability information for all global services. In particular, each control node maintains mapping information for a specified range of global services.

Whenever a portal requests to access a global service on the managed portal network, such as a desktop computer requesting to text chat, it sends a request to a discovery service on the nearest control node, which performs the functions necessary to identify the service type requested, and which peer portals have that service available. Throughout the service request process, this nearest node becomes the originating node. Once the discovery service has identified the server on the specific node having the requested service, the service request is passed on to the control node's authentication service.

The authentication process is relevant to the server hosting the service and the node the server is running on. First, the discovery service queries an indexing service on the originating node to find out which other control node on the network has the mapping information for the requested service. The indexing service returns the correct control node to the discovery service, which then contacts that control node directly.

The control node with the desired service mapping information returns a list of other control nodes, all of which have current connections to peer portals with the desired service available. Once this mapping control node passes on this list, its connection with the originating node is ended and no more interaction with it takes place. The discovery service uses this list to contact the relevant control nodes, and requests “scores” from each peer that has the desired service available. The criteria used to score is completely customizable for each configuration, and can include both user and performance-related criteria. The total number of peers that are included on a service mapping list, and the number of peers that receive scoring requests, are also customizable values.

Once the discovery service receives back a specified number of scores, it transmits that number of the scores back to the requesting peer portal. That peer selects one or more of these scored peers, depending on the needs of the requested service, and requests that the originating node create a VLAN between these peers and itself.

The originating node then sends connection directives to the requesting peer portal and the selected service peer or peers. If the requested service requires that connection data be maintained for a third party, then any VLAN using that service must also include a service controller for that service.

Once the VLAN is created, the peers each broadcast the peer services that they have available for the other peers in the VLAN. If two peers have the same service available (such as text chat), they can both select it and a text chat session is begun between them. If a service controller has been included in the VLAN, it records service activity, duration and other related data, and transmits that information back to a separate database. If another peer requests a VLAN connection for that same service, the originating node can add them to it, and the peer service lists are updated accordingly.

Each peer in a VLAN can add permissions to its peer service offerings, to prevent any or all peers in the VLAN from accessing them. For instance, if a kiosk wants to allow a PDA to access the kiosk's desktop, the kiosk offers the share feature as a restricted peer service to prevent any other peers in the VLAN from having access to the desktop.

The VLANs created in accordance with the present invention can be configured to terminate in one of two ways. First, when the requesting peer terminates its connection to the VLAN, the VLAN is ended by the originating node. Second, the VLAN can remain in session until all peers have terminated their connections to it. Whenever a VLAN is ended, however, any final data on the services used is sent to the service controller, which updates the relevant database.

Certain modifications and improvements will occur to those skilled in the art upon a reading of the forgoing description. All such modifications and improvements of the present invention have been deleted herein for the sake of conciseness and readability but are properly within the scope of the present invention.

1. A system for providing network load distribution comprising:
a network comprising a plurality of portals that are configured to access portal services hosted by the network; and
a plurality of control nodes on the network that are configured to establish data connections with the portals on the network;
wherein the control nodes form a virtual local area network (VLAN);
wherein the VLAN comprises multicast islands and singlecast bridges for broadcasting data to other nodes on the network;
wherein when a portal requests to access a portal service hosted on the network, a portal having the requested service is identified and authenticated by one of the control nodes, and a data connection is established between the identified portal and the requesting portal for sharing the requested service.
